(19) United States
(12) Patent Application Publication
(10) Pub. No.: US 2022/0005304 A1
(43) Pub. Date: Jan. 6, 2022

(54) ELECTRONIC VOTING ASSISTANT

(71) Applicant: Open Invest Co., San Francisco, CA (US)

(72) Inventors: Conor MURRAY, San Francisco, CA (US); Joshua LEVIN, San Francisco, CA (US); Phillip WEI, San Francisco, CA (US)

(73) Assignee: Open Invest Co., San Francisco, CA (US)

(21) Appl. No.: 17/282,738

(22) PCT Filed: Sep. 21, 2018
(86) PCT No.: PCT/US2018/052280

§ 371 Date: Apr. 2, 2021

Related U.S. Application Data
(60) Provisional application No. 62/562,333, filed on Sep. 22, 2017.

(51) Int. Cl. G07C 13/00; G06Q 50/26

(52) U.S. Cl. CPC G07C 13/00; G06Q 2230/00; G06Q 50/26

(57) ABSTRACT

A method is disclosed, the method comprising the steps of identifying a voting right corresponding to a user; identifying, based on the voting right, a ballot question; determining whether the ballot question is sufficiently relevant to the user; in accordance with a determination that the ballot question is sufficiently relevant to the user: presenting the ballot question to the user, and in response to presenting the ballot question to the user, receiving input from the user; and in accordance with a determination that the ballot question is not sufficiently relevant to the user, forgoing presenting the ballot question to the user.

### CROSS REFERENCE FOR RELATED APPLICATION

This application claims the benefit under 35 U.S.C. 119(e) of U.S. Provisional Patent Application No. 62/562,333, filed Sep. 22, 2017 the contents of which are incorporated herein by reference in their entirety for all purposes.

### FIELD OF THE INVENTION

The present invention relates to systems and methods for voting.

### BACKGROUND OF THE INVENTION

A reality of modern elections—governmental, corporate, social, and otherwise—is that they suffer from low voter turnout, caused in part by low awareness and engagement among would-be voters. Low turnout can be connected to complaints, common among would-be voters, of feeling disillusioned with the voting process. Some such voters may feel devalued and disengaged, seeing little relevance of ballot issues to one's own values and beliefs. Some may feel confused and overwhelmed by an increasingly complex and technical process. Some may feel alone and alienated in a voting system that values secrecy and privacy. Some may not believe there is any meaningful consequence of their lonely vote—contributing to the so-called “tragedy of the commons,” in which the actions of many individuals collectively have significant unwanted consequences for the group. Some may not recognize or understand the voting rights they have, which elections those rights correspond to, or what the issues are in those elections. Some may be uninformed of the issues, or confused by ever-increasing amounts of information and misinformation surrounding elections. Such complaints may carry extra weight in the context of corporate voting, where corporate elections can feature complex rules and a byzantine web of ballot measures—many irrelevant to most shareholders—that deter all from the largest and most sophisticated shareholders from exercising their voting rights.

One consequence of low voter engagement is that it can distort the electoral process itself. Elections can only reflect the wishes of those who actually turn out to vote—not the electorate at large. Poor voter turnout frequently does not strike evenly; for example, it can disproportionately affect would-be voters along demographic lines, potentially disenfranchising entire groups of people who are entitled to a voice in the political process.

Current voting interfaces—whether on paper, electronic (such as via mobile devices), or otherwise—are cumbersome and complex in a mobile world that values elegance, speed, clarity, and simplicity. Further, current voting systems, which frequently prioritize security and privacy above all else, offer the voter little insight into the election process, or any sense of connection to other voters. More broadly, aspects the basic act of voting itself, as implemented in many elections, are outdated in view of the modern ways people prefer to engage with technology, and with other people. Whereas voting is traditionally an act of secrecy—a private act behind a closed curtain—many voters today view electoral engagement as a social activity. Voters want affirmation that their votes reflect their values. They want their own civic engagement to connect them to others—not to isolate them. Voters want to understand what we are all voting for, why we are voting for it, and what effect it will have on our own lives. Voters want to cut through the noise and the misinformation, and engage with what is most significant to them. In many cases, what is most significant to voters—even more than the ballot issues themselves—are the opinions and approval of their own friends and family.

A solution is needed that can improve voter turnout and engagement, by bringing an underused voting process into harmony with how a modern voting public prefers to exercise its voting rights.

### SUMMARY OF THE INVENTION

The presently disclosed examples are directed to solving one or more of the problems presented in the prior art, as well as providing additional features that will become readily apparent by reference to the following detailed description when taken in conjunction with the accompanying drawings. In some examples, a method of receiving a voting preference according to examples of the disclosure comprises the steps of identifying a voting right corresponding to a user; identifying, based on the voting right, a ballot question; determining whether the ballot question is sufficiently relevant to the user; in accordance with a determination that the ballot question is sufficiently relevant to the user; presenting the ballot question to the user, and in response to presenting the ballot question to the user, receiving input from the user; and in accordance with a determination that the ballot question is not sufficiently relevant to the user, forgoing presenting the ballot question to the user.

### BRIEF DESCRIPTION OF DRAWINGS

FIG. 1 depicts a flow chart for an example voting preference manager according to examples of the disclosure.

FIG. 2 depicts an example of associating ballot issue tags with a ballot question according to examples of the disclosure.

FIG. 3 depicts an example of associating voter issue tags with a voter according to examples of the disclosure.

FIGS. 4A-4C depict an example of presenting a ballot question to a voter and listening for voter input according to examples of the disclosure.

FIG. 5 depicts an example computer system for implementing an example voting preference manager according to examples of the disclosure.

### DETAILED DESCRIPTION

Disclosed herein are devices, systems, methods, and computer-readable media for a voting preference manager (“VPM”). A VPM may be configured to identify one or more ballot questions for a voter, present the one or more ballot questions to the voter, and receive the voter's input (e.g., input expressing a voting preference with respect to a ballot question) in response to the one or more ballot questions. A VPM may be implemented in any suitable configuration of computer hardware and/or software. For example, a VPM may be implemented using a computer server that communicates with a voter via email, text message (e.g., SMS, MMS), a social media service (e.g., Facebook, Twitter, Snapchat), or a mobile device application.

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

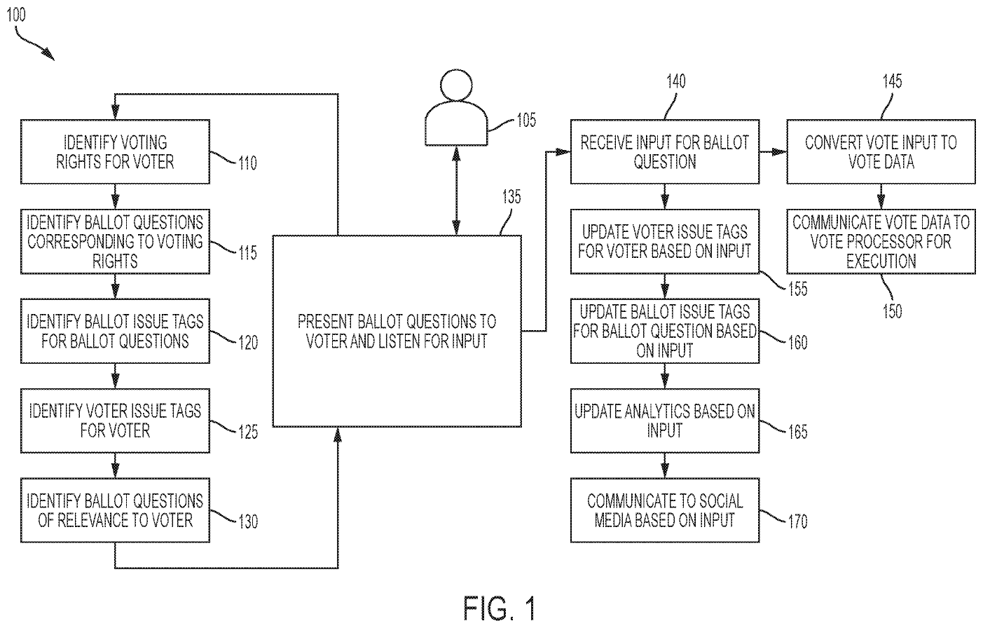

FIG. 1 depicts an example VPM 100 according to examples of the disclosure. In the example, VPM 100 may interact with a single voter 105, who may be considered a user of VPM 100. However, in some examples, VPM 100 may interact with two or more voters, including (in some examples) two or more voters simultaneously.

As shown in FIG. 1, at stage 110, VPM 100 identifies one or more voting rights belonging to voter 105. A voting right is a right of an entity (e.g., an individual) to vote on a ballot question in an election. For example, at stage 110, VPM 100 may identify voter 105 as a shareholder of a fictional corporation, BoxCorp, with the right to vote on proxy ballots put to shareholders of BoxCorp. As another example, VPM 100 may identify voter 105 as an adult citizen of the United States and a resident of the state of California, and thus that he or she has the right to vote in national (U.S.) and state (California) elections.

VPM 100 may identify voting rights information for voter 105 in any number of suitable ways. In some examples, such as for government elections, VPM 100 may obtain voting rights information for voter 105 via a list or database maintained by a central authority. For instance, in the case of government elections, VPM 100 may obtain voting rights information from public voter rolls maintained by a public authority (e.g., the California Secretary of State). In some examples, such as for an election for a corporation, voting rights information may be provided to VPM 100 by the corporation itself, such as via a list of shareholders having voting rights. In some examples, VPM 100 can obtain voting rights information from third-party services and databases, such as Broadridge, Broadridge's ProxyEdge system, or Broadridge's ProxyVote.com system, or from records of transactions of that corporation's shares. In some examples, VPM 100 can obtain a list of the client's eligible shares via an investment manager, Registered Investment Advisor (RIA), broker-dealer, or custodian. In some examples, voting rights information may be self-reported by voter 105, and in some cases verified by VPM 100.

At stage 115 in the example shown in FIG. 1, VPM 100 identifies ballot questions that voter 105 is eligible to vote on, based on voter 105's voting rights. For example, if voter 105 is a shareholder of BoxCorp with voting rights, VPM 100 may identify ballot questions (e.g., via a third-party electronic system, the company's official proxy statement, or another form of proxy card) that are scheduled to be presented to the voting shareholders of BoxCorp. In some examples, identifying ballot questions comprises receiving the ballot questions that voter 105 is eligible to vote on from third-party services and databases, such as Broadridge, Broadridge's ProxyEdge system, or Broadridge's ProxyVote.com system. VPM 100 may further identify information relating to each ballot question, such as the issues relating to the ballot question; the history of those issues; options presented to voters; key people associated with the ballot question; the likely impact of the ballot question; and any other suitable information. In some cases, this information may be gathered using public search tools, or specialized research services, such as election-specific databases or policy analysis materials. In some cases, such as for corporate elections, this information may be obtained from corporate information services and market analysis services (e.g., market research reports for a particular company, industry, or issue). As another example, if voter 105 is a citizen of the United States, VPM 100 may identify upcoming U.S. national elections in which voter 105 is eligible to vote. VPM 100 may further identify information relating to ballot questions in those elections, such as which candidates, parties, and offices are up for election; position statements released by the candidates; public information (e.g., voting histories) relating to the candidates; polling information; third-party election analysis; reports and statements by third party interest groups; and any other suitable information. This information may be gathered, for example, from public sources, such as newspapers and journals; from election officials; or from specialized research services.

At stage 120 in the example shown in FIG. 1, VPM 100 associates each eligible ballot question identified in stage 115 with one or more ballot issue tags. A ballot issue tag could correspond to one or more of an issue (e.g., gun rights), a value or belief (e.g., the wealthy should pay fewer taxes), a person (e.g., the President of the United States), a location (e.g., Washington, D.C.), a group (e.g., military veterans), etc. (Throughout the disclosure, for simplicity, “issue” may be used to refer to an issue, a value, a belief, a person, a location, a group, or another concept relevant to a ballot question or to a voter.) A ballot issue tag can correspond to any characteristic of a ballot question that affects how a voter votes on the ballot question. For example, the issue of a gender pay gap could be a ballot issue tag that may impact a voter's vote on an issue: if a ballot question implicates the issue of gender pay gap (e.g., the outcome of the vote will determine whether a gender pay gap is increased or decreased), a voter's position with respect to that issue may affect how the voter votes on that ballot question.

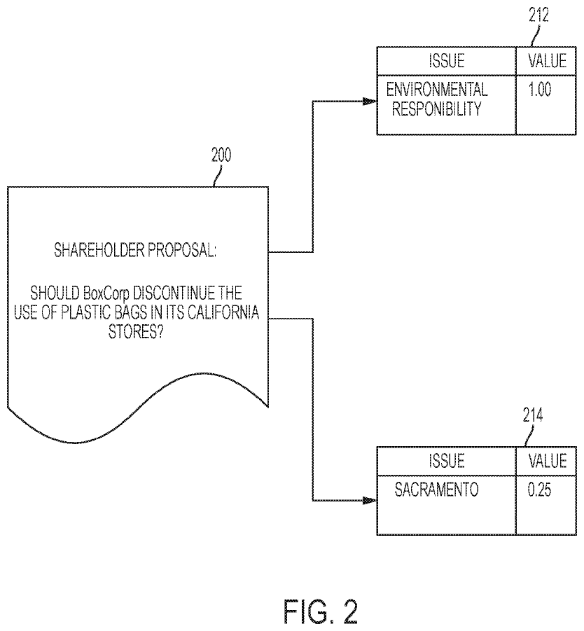

FIG. 2 illustrates an example of associating a ballot issue tag with a ballot question. In FIG. 2, example ballot question 200 is a ballot question on a proxy statement for BoxCorp, a fictional example corporation that is a national retailer. In the example shown, ballot question 200 presents the voter with an option to vote either “Yes” or “No” on a shareholder proposal for BoxCorp to discontinue using plastic bags in its California stores. In the example shown, ballot question 200 is associated with a first ballot issue tag 212 and a second ballot issue tag 214. Each of first ballot issue tag 212 and second ballot issue tag 214 corresponds to an issue implicated by ballot question 200. In the example, first ballot issue tag 212 corresponds to “environmental responsibility.” and second ballot issue tag 214 corresponds to “Sacramento,” which are both issues implicated by the proposal in ballot question 200 (plastic bags may be environmentally harmful; Sacramento is a city in California). In some examples, VPM 100 may assign a strength value to a ballot issue tag, indicating how closely related the ballot issue tag is to a ballot question. For example, in the example shown in FIG. 2, first ballot issue tag 212 includes a strength value of 1.00 to indicate that environmental responsibility is relatively strongly implicated by ballot question 200 (e.g., BoxCorp may currently be using a very large number of plastic bags). Similarly, in the example, second ballot issue tag 214 includes a strength value of 0.25 to indicate that Sacramento is less strongly implicated by ballot question 200 (e.g., BoxCorp may have only a few retail sales in Sacramento).

While FIG. 2 illustrates a ballot issue tag associating a ballot question with an issue using a single strength value, any suitable data structure or implementation may be used to associate an issue with a ballot question. For instance, a particular data structure or implementation can be selected to express a complex relationship between ballot question 200 and an issue. This may be especially desirable where the implications of ballot question 200 may depend on some fact, event, or belief, or on another issue, external to the ballot question itself. For example, with reference to ballot question 200 (which relates to BoxCorp banning plastic bags in its California stores) and ballot issue tag 214 (which relates to the “issue” of Sacramento), the relevance of Sacramento to ballot question 200 may depend on external facts. For instance, if BoxCorp recently opened a dozen new stores in Sacramento, the ballot question may be highly relevant. Conversely, if BoxCorp recently closed all of its Sacramento stores, the ballot question may be barely relevant at all. A data structure can be selected for ballot issue tag 214 that reflects this conditional relationship between ballot question 200 and the issue of Sacramento. Further, in some examples a ballot issue tag may associate an issue with some logic or software (e.g., an executable computer program), instead of or in addition to a data structure. For instance, ballot issue tag 214 could associate (e.g., via a function pointer) the issue of Sacramento with a computer program, which can be executed to output a value corresponding to the relevance of ballot question 200 to the issue of Sacramento (e.g., by querying values, such as current sales figures, relating to BoxCorp's operations in Sacramento). This may be particularly useful when the relevance of an issue to a ballot question is dependent on dynamic factors that are most appropriately accounted for by a computer program, rather than by a static data value.

Various techniques may be used to create a ballot issue tag and/or associate a ballot issue tag with a ballot question. In some examples, a ballot issue tag may be generated from the text of the ballot question itself, for example by using text recognition and analysis software to identify the issues implicated by a ballot question. In some examples, a ballot question may be manually associated with a ballot issue tag, such as by reviewing the ballot question and identifying issues implicated by that ballot question. This may be done, for instance, by the entity responsible for creating the ballot questions (e.g., a committee of shareholders); by an election oversight entity; or by a third party. In some examples, a crowdsourcing model may be used to associate ballot questions with ballot issue tags, such as where ballot questions are reviewed and tagged by members of the public (e.g., internet users). Similarly, in some examples, social media services may be incorporated into the process, such as by encouraging social media users and groups to review and tag ballot questions. In some examples, ballot issue tags may be created or associated with a ballot question by, or in conjunction with, a third-party individual or organization, such as a service provider; a data provider; a non-governmental organization; or an issue expert. Additionally, in some examples, ballot issue tags can be created, associated with a ballot question, or adjusted, based on vote data, such as records of how voters voted on various ballot questions. For instance, if a group of voters votes on a particular ballot question, a ballot issue tag could be created for that ballot question based on a characteristic common to those voters (e.g., the voters all live in California).

At stage 120 in the example shown in FIG. 1, VPM 100 associates one or more voter issue tags with voter 105. As with ballot issue tags, voter issue tags can correspond to one or more of an issue (e.g., gun control), a value or belief (e.g., the wealthy should pay fewer taxes), a person (e.g., the President of the United States), a location (e.g., Washington, D.C.), a group (e.g., military veterans), etc. A voter issue tag can correspond to anything of importance to a voter that affects how interested the voter might be in voting on a ballot question, and/or how the voter might prefer to vote on a ballot question. For example, if the issue of environmental regulations is important to a voter, that voter may be particularly interested in voting on ballot questions that implicate environmental regulations.

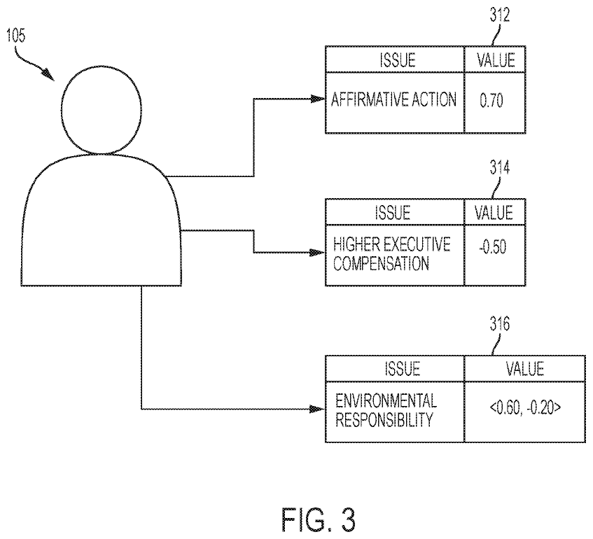

FIG. 3 illustrates an example of associating a voter issue tag with a voter. In the example shown, voter 105 is associated with first voter issue tag 312, second voter issue tag 314, and third voter issue tag 316. In the example shown, first voter issue tag 312 corresponds to “affirmative action,” second voter issue tag 314 corresponds to “higher executive compensation,” and third voter issue tag 316 corresponds to “environmental responsibility,” all three of which are issues of some importance to voter 105 (which may be determined as described further below). In some examples, as described above with respect to ballot issue tags, VPM 100 may assign a strength value to a voter issue tag, indicating how important the issue is to voter 105. For example, in the example shown in FIG. 3, first voter issue tag 312 includes a strength value of 0.70 to indicate that affirmative action is relatively important to voter 105. In some examples, a voter issue tag may include “directional” information about an issue—that is, information that relates to which way a voter feels about the issue. For example, in FIG. 3, second voter issue tag 314 includes a strength value of −0.50, the negative value indicating that voter 105 opposes higher executive compensation (a positive value could indicate that voter 105 supports it). Further, the magnitude of the strength value (e.g., 0.50 for second voter issue tag 314) could indicate how strongly the voter supports or opposes the associated issue. In some examples, a voter issue tag may include a multidimensional vector, instead of or in addition to a single strength value, to indicate a voter's support or opposition to two or more aspects of an issue. For example, in FIG. 3, third voter issue tag 316 includes a vector strength value of <0.60, −0.20>, corresponding to the degree of support or opposition that voter 105 has to two aspects of environmental responsibility. For instance, in third voter issue tag 316, the positive strength value (0.60) of the first vector dimension could indicate that voter 105 supports eliminating the use of environmentally harmful packaging materials; while the negative strength value (−0.20) of the second vector dimension could indicate that voter 105 opposes stricter emissions standards. Conversely, a negative first strength value and a positive second strength value could indicate that voter 105 opposes eliminating the use of environmentally harmful packaging materials; but supports stricter emissions standards. The vector could be extended to any number of dimensions. In this way, the voter issue tag can reflect a nuanced indication of a voter's opinion on an issue, beyond merely “support” or “oppose.”

Any suitable data structure or implementation may be associated with an issue in a voter issue tag. For instance, a particular data structure or implementation can be selected to express a complex relationship between voter 105 and an issue. This may be especially desirable where voter 105 may have beliefs on an issue that are conditioned on some fact, event, or belief, or on another issue. For example, with reference to voter issue tag 314 (which relates to higher executive compensation), voter 105 may support higher executive compensation if the state minimum wage is increased, but may oppose higher executive compensation if the state minimum wage is decreased or unchanged. A data structure can be selected for voter issue tag 314 that reflects this conditional relationship between voter 105 and the issue of higher executive compensation. Further, in some examples a voter issue tag may associate an issue with some logic or software (e.g., an executable computer program), instead of or in addition to a data structure. For instance, voter issue tag 314 could associate (e.g., via a function pointer) the issue of higher executive compensation with a computer program, which can be executed to output a value corresponding to the opinion of voter 105 on the issue of higher executive compensation. This may be particularly useful when a voter's opinion is dependent on dynamic factors that are most appropriately accounted for by a computer program, rather than a static data value.

While example voter issue tags of various levels of complexity are described above, VPM 100 may use various types of voter issue tags at any level of complexity. For example, in some implementations, VPM 100 may only utilize simple voter issue tags comprising a single strength value greater than zero (e.g., as in first voter issue tag 312 described above). In some examples, VPM 100 may utilize simple voter issue tags (e.g., first voter issue tag 312) in conjunction with one or more voter issue tags of greater complexity (e.g., second voter issue tag 314 or third voter issue tag 316). Any combination of voter issue tags, and types of voter issue tags, is within the scope of the disclosure.

Various techniques may be used to create a voter issue tag and/or associate a voter issue tag with a voter. In some examples, voter issue tags may be generated directly from information provided by the voter; for instance, the voter could complete an electronic questionnaire (e.g., by filling out form-fields on a webpage or mobile application, or by selecting among icons or buttons on a webpage or mobile application), including questions designed to elicit issues that are important to the voter, with the questionnaire results then translated into voter issue tags. In some examples, voter issue tags may be created or associated with a voter by, or in conjunction with, a third-party individual or organization, such as a service provider; a data provider; a non-governmental organization; or an issue expert. Additionally, in some examples, voter issue tags can be created, associated with a voter, or adjusted, based on vote data, such as records of how voters voted on various ballot questions. For instance, if a group of voters votes on a particular ballot question, a voter issue tag could be created for those voters based on a characteristic of that ballot question (e.g., the ballot question relates to the issue of California).

In some examples, factual information known about a voter (e.g., demographic information) may be used to identify issues that may be important to the voter; for example, a female voter of age 25 may be interested in issues affecting women in that same age group. Further, a voter's voting history can be used to generate and associate voter issue tags, or to update existing tags; for instance, if a voter consistently votes on ballot questions pertaining to a particular issue, that voting history could be used to create a voting issue tag corresponding to that issue. In some examples, social media services can be used to create or associate voter issue tags; that is, data on a social media service associated with a voter, such as photos, videos, biographical information, personal preferences, and user-generated content, may be analyzed (e.g., using machine learning and artificial intelligence techniques) to determine issues important to that voter. For instance, if a voter indicates an interest in an issue via social media (e.g., by “Liking” that issue, or groups interested in that issue, on Facebook), that information can be used to create a voting issue tag corresponding to that issue. Similarly, if a voter posts content on social media pertaining to an issue (as may be determined, for example, by text recognition and analysis software), that information can be used to create a voting issue tag corresponding to that issue. Further, information about a voter's social media friends and groups can be used to create or associate voter issue tags. For instance, if a large number of a voter's Facebook friends express an interest in an issue, it may be inferred that the voter is also interested in that issue; and a voter issue tag corresponding to that issue may be created accordingly.

At stage 130 of the example shown in FIG. 1, VPM 100 can identify which ballot questions are sufficiently relevant to voter 105, such as by using the voter issue tags and the ballot issue tags to identify, ballot questions that implicate the same issues that a user is interested in. In some examples, voter issue tags and ballot issue tags can correspond (directly or indirectly) to the same underlying issues, facilitating this process. In some examples, VPM 100 can maintain a list of ballot questions (e.g., ballot question 200) and their associated ballot issue tags (e.g., ballot issue tags 212 and 214). For a voter (e.g., voter 105), VPM 100 can identify the voter issue tags associated with that voter (e.g., voter issue tags 312, 314, and 316). VPM 100 can then identify sufficiently relevant ballot questions by locating ballot questions in the list whose ballot issue tags sufficiently relate to (e.g., correspond to, or overlap with) one or more of the same issues identified by the voter issue tags. For instance, VPM 100 could identify ballot question 200 as sufficiently relevant to voter 105 by determining that ballot issue tag 212 indicates that ballot question 200 implicates environmental responsibility; and that voter issue tag 316 indicates that the same issue, environmental responsibility, is important to voter 105. Conversely, VPM 100 could identify a ballot question as insufficiently relevant if the ballot question does not implicate an issue that is important to voter 105 (e.g., the ballot question is not associated with any ballot issue tags corresponding to issues shared with voter issue tags for voter 105). In some examples, VPM 100 may identify other relationships between a ballot issue tag and a voter issue tag. In some examples, VPM 100 could use data from voting records or other public records to identify a relationship between a voter issue tag and a ballot issue tag. For instance, voting records could indicate that voters associated with a particular voter issue tag also tend to vote frequently, and perhaps in a certain way, on ballot questions associated with a particular ballot issue tag—indicating that the voter issue tag and the ballot issue tag are related in such a way that the ballot question associated with the ballot issue tag is relevant to a voter associated with the voter issue tag. In some examples, VPM 100 could use biographical or social information (e.g., from social media services utilized by voter 105) to identify a relationship between a voter issue tag and a ballot issue tag. For instance, social media data could indicate that social media users associated with a particular voter issue tag share interests, or post content, related to a particular ballot issue tag. This could indicate that ballot questions associated with that ballot issue tag may be relevant to those users.

In some examples, VPM 100 can not only identify sufficiently relevant ballot questions, but also identify a degree to which such ballot questions are relevant. This information can be used to present the voter with a limited list of ballot questions (e.g., to make the list more manageable for voters with many relevant ballot questions); or to present the voter with a list of ballot questions that is sorted by relevance (e.g., such that the most relevant ballot questions are most easily accessible to the voter). In some examples, the number or type of ballot questions shown to voter 105 can depend on how frequently voter 105 votes, for instance, if voter 105 is a frequent voter, it may be desirable for VPM 100 to show voter 105 a greater number of ballot questions than VPM 100 would show if voter 105 were only an occasional voter. In some examples, VPM 100 can identify the ballot questions most relevant to a voter by identifying those with the greatest number of ballot issue tags that correspond to that voter's voter issue tags; that is, the ballot questions that implicate the most issues that the voter cares about can be identified as most relevant. Further, in some examples where ballot issue tags include a strength value, VPM 100 can use the strength values to identify the most relevant ballot questions. For instance, the ballot questions that most strongly implicate the issues (as measured by the respective strength values of the ballot issue tags) that the voter cares about can be identified as most relevant. Additionally, in some examples where voter issue tags include a strength value, VPM 100 can use the strength values to further identify the most relevant ballot questions. For instance, the ballot questions that implicate the issues the voter most strongly cares about (as measured by the respective strength values of the voter issue tags) can be identified as most relevant. In some examples, as described above, ballot issue tags and/or voter issue tags can include logic or software for identifying a voter or a ballot question with an issue; such logic or software could comprise custom logic for determining how relevant a ballot question is to a voter. In some examples, identifying the relevance of a ballot question to a voter can be performed by, or in conjunction with, a third-party individual or organization, such as a service provider; a data provider; a non-governmental organization; or an issue expert. Additionally, in some examples, the relevance of a ballot question to a voter can be determined, or adjusted, based on vote data, such as records of how voters voted on various ballot questions. For instance, if a group of voters votes on a particular ballot question, the relevance of that ballot question to a voter could be determined based on a characteristic of that ballot question (e.g., the ballot question relates to the issue of California) and/or a characteristic of the group (e.g., the group of voters are all California residents). While the above techniques are described for identifying relevant ballot questions, and/or identifying how relevant one ballot question is relative to another, other techniques for will be familiar to those skilled in the art, and the disclosure is not limited to any such technique.

Any suitable data structure may be used to represent a ballot question, such as ballot question 200. Similarly, any suitable data structure may be used to represent a ballot issue tag, such as first ballot issue tag 212 or second ballot issue tag 214. Moreover, any suitable data structure may be used to represent a voter issue tag, such as first voter issue tag 312, second voter issue tag 314, or third voter issue tag 316. The disclosure is not limited to any particular structure, representation, or implementation of this data. For example, while FIG. 2 shows ballot issue tags 212 and 214 as separate entities, an example of the disclosure could represent both ballot issue tags as a single entity, such as a list, a set, an array, or any other suitable structure. Similarly, while FIG. 3 shows voter issue tags 312, 314, and 316 as separate entities, an example of the disclosure could represent all three voter issue tags as a single entity, such as a list, a set, an array, or any other suitable structure. Other suitable ways of representing the data used by VPM 100 will be apparent to those skilled in the art and are contemplated by the disclosure.

At stage 135 in the example shown in FIG. 1, if ballot questions were identified at stage 130, VPM 100 presents voter 105 with one or more such ballot questions, and presents voter 105 with an opportunity to provide input in response to those ballot questions. Such input may reflect a voting preference with respect to a ballot question. For instance, at stage 135, ballot questions identified (e.g., at stage 130) as sufficiently relevant to voter 105 can be presented to voter 105. Similarly, ballot questions not identified (e.g., at stage 130) as sufficiently relevant to voter 105 may not be presented to voter 105. The presentation to voter 105 can take any suitable form. For example, ballot questions could be presented, and input received, using email, text message (e.g., SMS, MMS); a social media service (e.g., Facebook, Twitter, Snapchat); an application for a desktop or laptop computer; an application for a mobile device, such as a smartphone with a touch screen; an audio system comprising a voice recognition system; or any other suitable means of presentation. In some examples, ballot questions may be presented simultaneously using two or more means of presentation (such as any of the above). In some examples, the presentation at stage 135 may be part of a larger presentation to voter 105. For instance, some examples may incorporate one or more of a graphical front end; portal; a search engine interface; a feed of information (e.g., a real-time news feed); integration with social media services (e.g., Facebook content updates); factual information relating to ballot questions (e.g., stock market updates presented alongside corporate ballot questions; biographical information relating to candidates in a government election); or any other suitable information.

In some examples, the presentation at stage 135 may occur in parallel with one or more of stages 110, 115, 120, 125, and/or 130 described above with respect to FIG. 1. For example, while presentation to voter 105 is occurring in stage 135, VPM 100 could concurrently be identifying or updating the voting rights belonging to voter 105; identifying or updating ballot questions to which voter 105 has voting rights; identifying or updating ballot issue tags for ballot questions; identifying or updating voter issue tags for voter 105; and/or identifying or updating ballot questions relevant to voter 105. Similarly, while presentation to voter 105 is occurring in stage 135, the presentation could be updated in real time to reflect the latest results of any of stages 110, 115, 120, 125, or 130.

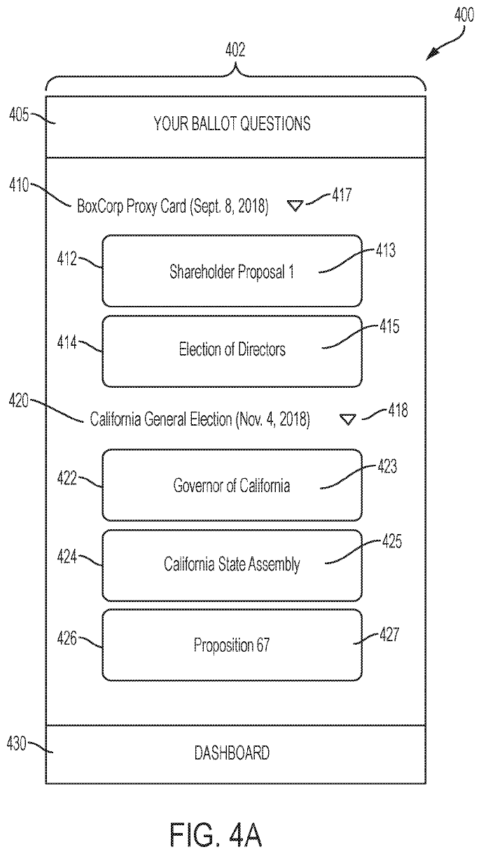

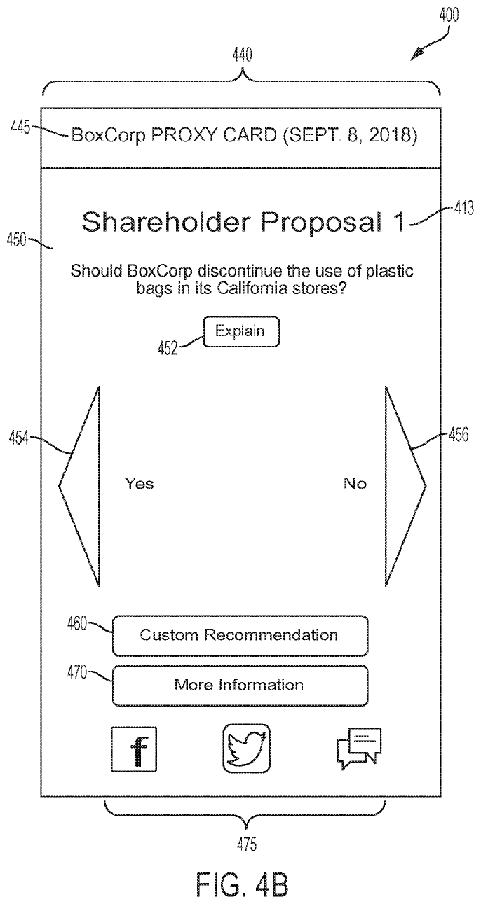

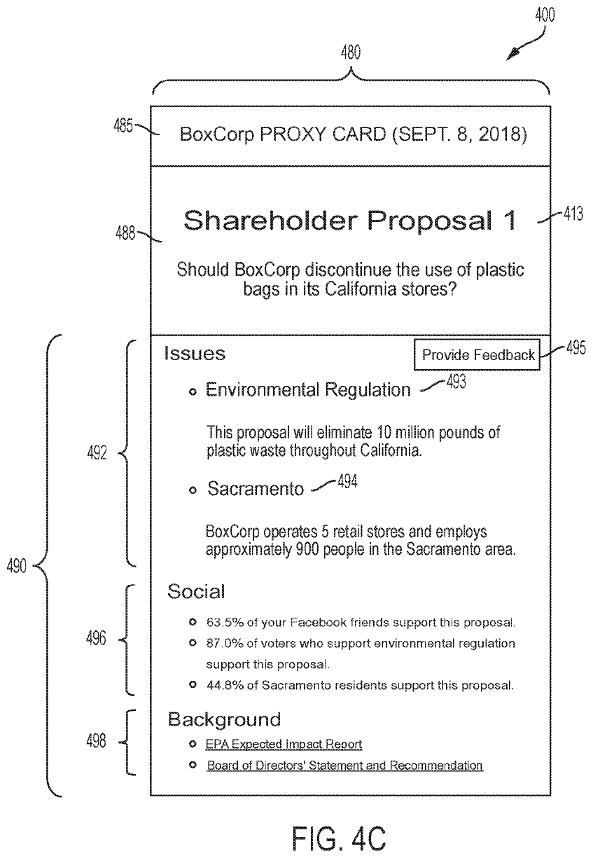

FIGS. 4A-4C depict an example of presenting one or more ballot questions to a voter and listening for voter input, such as at stage 135, according to examples of the disclosure. In the example shown in FIGS. 4A-4C, the presentation may use a smartphone application through which graphical and/or audio data is presented (e.g., via a screen and/or speakers of the smartphone), and through which user input is received (e.g., via a touch screen, microphone, camera, sensor, and/or physical buttons of the smartphone). However, as described above, the disclosure is not limited to implementation using a smartphone application; and the disclosure encompasses any suitable means of presentation. Further, in some examples that include a smartphone application, the smartphone application need not be dedicated to the presentation at stage 135; in some examples, presentation at 135 may be performed using a host application (e.g., a social media application or web browser application) that incorporates some or all of the functionality described herein.

FIG. 4A shows an example view 402 of an example smartphone application 400 for use by VPM 100 to present ballot questions to voter 105. View 402 may represent a view presented to voter 105 in response to input from voter 105—for example, a request to open a dedicated smartphone application (e.g., in response to a push notification); a request (e.g., in response to an in-app alert) to enter a ballot question view of a smartphone application that includes additional functionality (e.g., a social media application or a web browser application); or a selection of an internet link, such as via a text messaging application or a web browser. Views of application 400, such as view 402, may comprise one or more visual regions for displaying content on a display. In some examples, one or more such regions may be scrollable regions that can be scrolled by the user to hide and reveal content in the region. In this way, the scrollable regions can be used to display an arbitrarily large amount of information. Other suitable options for presenting data in a region of application 400 will be apparent and are contemplated by the disclosure.

In the example view 402, a header region 405 (“Your Ballot Questions”) of view 402 indicates to voter 105 that view 402 corresponds to ballot questions that have been selected for presentation to voter 105 (e.g., ballot questions that have been determined to be sufficiently relevant to voter 105). In view 402, selectable user interface buttons corresponding to the ballot questions presented are organized by the election or ballot that the ballot questions belong to. For example, in view 402, the ballot questions may be organized under heading 410 (corresponding to a BoxCorp Proxy Card for Sep. 8, 2018) or heading 420 (corresponding to a California General Election for Nov. 4, 2018). In example view 402, heading 410 includes ballot question buttons 412 (corresponding to ballot question 413, Shareholder Proposal 1) and 414 (corresponding to ballot question 415, an Election of Directors). Similarly, heading 420 includes ballot question buttons 422 (corresponding to ballot question 423, an election for Governor of California), 424 (corresponding to ballot question 425, an election for California State Assembly), and 426 (corresponding to ballot question 427, Proposition 67). While only two headings and five ballot questions are shown in example view 402, any number of headings and/or ballot questions (including zero, as appropriate) may be included. For example, voter 105 may scroll up or down through view 402 to reveal additional headings and/or ballot questions. Additionally, voter 105 may select carat icons 417 and/or 418 to expand and/or collapse headings 410 and/or 420, respectively, which may show or hide the ballot question buttons presented under their respective headings. In some examples, ballot questions (e.g., ballot questions 412, 414, 422, 424, and 426) could be presented to voter 105 in a specific order, such as in order of relevance to their voter 105, as determined in stage 130, as described above. At the bottom of example view 402, a selectable user interface button 430 (“Dashboard”) may be selected to bring voter 105 to a dashboard view, which may allow voter 105 to view and/or edit profile information (e.g., biographical information corresponding to voter 105); statistical data (e.g., voting history for voter 105); analytical information (e.g., correlations of election results to real-world events, such as changes in stock prices); social media information (e.g., friends' recent social media activity); content feeds (e.g., news feed, stock ticker); or other suitable information and functionality. View 402 may also include other suitable user interface elements as appropriate. In some examples, view 402 does not display ballot questions that have not been determined to be sufficiently relevant to voter 105.

In the example shown in FIGS. 4A-4C, selecting a user interface button (e.g., one of buttons 412, 414, 422, 424, or 426) for a ballot question (e.g., one of ballot questions 413, 415, 423, 425, or 427) will bring voter 105 to a separate view corresponding to that ballot question. FIG. 4B depicts an example view 440 corresponding to such a view. View 440 is an example interface through which voter 105 is presented with a ballot question, and can provide corresponding input to VPM 100 (e.g., input indicating a voting preference for the ballot question). In FIG. 4B, view 440 corresponds to the ballot question 413 (Shareholder Proposal 1); voter 105 may be presented with view 440 in response to selecting button 412 (e.g., via tapping a smartphone touch screen), which as indicated above corresponds to ballot question 413. In view 440, a header region 445 identifies the title of a ballot or election to which the ballot question belongs (e.g., BoxCorp Proxy Card for Sep. 8, 2018). This title may correspond to a heading (e.g., heading 410) to which the selected ballot question (e.g., ballot question 413) belongs in example view 402. In view 440, region 450 identifies the ballot question at hand (e.g., ballot question 413), and presents voter 105 with the text of the ballot question (e.g., “Should BoxCorp discontinue the use of plastic bags in its California stores?”). In some examples, region 450 may not present the literal text of ballot question 413, but may instead present a summarized, paraphrased, or translated version of the ballot question 413. In some examples, view 440 may include a user interface button, such as button 452, that voter 105 can select to view an explanation of ballot question 413. For example, selecting button 452 might present voter 105 with the complete text of ballot question 413 (if not already visible); definitions of words used in ballot question 413; key people associated with ballot question 413; an explanation of the meaning of ballot question 413; and/or contextual information associated with ballot question 413.

In view 440, regions 454 and 456 correspond to input regions of view 440 for voter 105 to enter input in response to the ballot question presented (e.g., ballot question 413). Such input may indicate a voting preference of voter 105 with respect to the ballot question. For example, input region 454 may include a left arrow icon and the word “Yes” (or a graphical icon, such as a thumbs up), indicating that voter 105 can enter input (such as in input region 454) to express a preference to vote Yes on ballot question 413. For example, this input could be provided by tapping input region 454 on a touch screen; by clicking input region 454 with a mouse or other user interface device; by performing a gesture (e.g., a swipe left gesture); or by entering text input (e.g., writing the word “Yes” on a smartphone touchscreen). Conversely, input region 456 may include a right arrow icon and the word “No” (or a graphical icon, such as a thumbs down), indicating that voter 105 can enter input (such as in input region 456) to express a preference to vote No on ballot question 413. For example, this input could be provided by tapping input region 456 on a touch screen; by clicking input region 456 with a mouse or other user interface device; by performing a gesture (e.g., a swipe right gesture); or by entering text input (e.g., writing the word “No” on a smartphone touchscreen). Other suitable forms of input will be apparent and are within the scope of the disclosure. The specific contents of input regions 454 and 456 may depend on the nature of the ballot question presented and the type of input desired. For instance, if the ballot question requires voter 105 to select a candidate from a list of candidates, view 440 may present a series of checkboxes corresponding to the candidates, and voter 105 may provide input in the form of selecting and deselecting the checkboxes. Similarly, some ballot questions may present voter 105 with more choices than just “Yes” or “No”; if view 440 includes such a question, view 440 may include any number of input regions (e.g., three input regions) appropriate to the number of options presented. The disclosure is not limited to any number or type of input regions (including none at all); to any particular contents of such input regions; to any particular form of input that may be received from voter 105.

In some examples, VPM 100 may receive input provided by voter 105 via input regions of a view of application 400, such as input regions 454 or 456 of view 440. In some examples, voter 105 need not provide input specifically corresponding to a input region of application 400, such as input region 454 or input region 456. For instance, voter 105 may enter audio input (e.g., speaking “yes” or “no” into a smartphone microphone), visual input (e.g., performing a “thumbs up” or “thumbs down” gesture into a smartphone camera, or some other input not specifically directed to an input region of application 400. Moreover, in some examples, voter 105 may perform a gesture anywhere on a touch screen without regard to input regions such as regions 454 or 456; for instance, voter 105 could perform a swipe left gesture anywhere on a touch screen to vote yes, or could perform a swipe right gesture anywhere on the touch screen to vote no. Input received from voter 105 by VPM 100 is handled by VPM 100 as described further below.

In some examples, VPM 100 may present voter 105 with a personalized recommendation for responding to ballot question 413. For instance, view 440 of application 400 may include a selectable user interface button 460 that voter 105 can select for a recommendation. In response to voter 105 selecting button 460, VPM 100 may provide to voter 105 (e.g., via view 440) a recommendation for how voter 105 might prefer to vote on ballot question 413, based on one or more factors available to VPM 100. In some examples, VPM 100 can recommend how voter 105 might prefer to vote on ballot question 413 based on how voter 105 has voted on similar ballot questions in the past. In some examples, VPM 100 can recommend how voter 105 might prefer to vote based on voter issue tags associated with voter 105 (e.g., voter issue tags 312, 314, and 316 described above with respect to FIG. 3), for instance based on one or more strength values corresponding to such voter issue tags. This recommendation by VPM 100 may also incorporate ballot issue tags associated with ballot question 413 (e.g., ballot issue tags 212 and 214 described above with respect to FIG. 2). For instance, if voter issue tag 316 indicates that voter 105 generally supports increased environmental responsibility, and ballot issue tag 212 indicates that ballot question 413 proposed increasing environmental responsibility, then VPM 100 may provide a recommendation that voter 105 vote yes on ballot question 413. In some examples, VPM 100 may provide a recommendation based on social media information relating to voter 105; for instance, if social media friends of voter 105 overwhelmingly voted yes for ballot question 413, VPM 100 may recommend (based on a likelihood that voter 105 and his or her social media friends share common beliefs and values) that voter 105 vote yes on ballot question 413 as well. VPM 100 may provide a recommendation for voter 105 based on any one or more suitable factors, including those described above, and the disclosure is not limited to any type or number of such factors.

In some examples, application 400 may include options for voter 105 to engage with social media services with respect to ballot question 413. For example, view 440 may include selectable icons 475 corresponding to various social media services (e.g., Facebook, Twitter, etc.); in some examples, voter 105 can select one of icons 475 to post content relating to ballot question 413 to a corresponding social media service, or to otherwise engage with a social media service (e.g., by connecting to a social group interested in ballot question 413). In some examples, application 400 may incorporate information from ballot issue tags (e.g., ballot issue tags 212 or 214), or voter issue tags (e.g., voter issue tags 312, 314, or 316), into this social media integration. As one example, selecting one of icons 475 that corresponds to Twitter may present voter 105 with the option to post content to Twitter that is automatically tagged with a hashtag or other description corresponding to ballot question 413; application 400 may select a hashtag or other description corresponding to an issue identified by a ballot issue tag, such as ballot issue tag 212 or 214, associated with ballot question 413. As another example, selecting one of icons 475 that corresponds to Facebook may present voter 105 with a list of Facebook groups relating to an issue identified by a voter issue tag, such as voter issue tag 312, 314, or 316, associated with voter 105. Other ways in which application 400 can integrate with social media services will be apparent.

In some examples, VPM 100 may include its own proprietary social networking features, such as message boards on which various voters (e.g., voter 105 and other voters using VPM 100) can communicate. For example, such social networking features could include specific discussion forums or chat groups associated with specific issues or ballot questions (e.g., ballot question 413); repositories for voters to upload user-generated content (e.g., videos) associated with specific issues or ballot questions; public profiles associated with voters; or search features for voters to identify and connect with other voters with similar interests (e.g., voters who share common voter issue tags). In view 440, social media icons 475 may include one or more selectable icons that voter 105 can use to engage with such proprietary social networking features. In some examples, VPM 100 may include a feed of actions taken by voters associated with voter 105 (e.g., social media friends of voter 105, or voters that voter 105 has otherwise interacted with). Such feeds may be visible to the public, visible only to users of VPM 100, or some combination. In some examples, such feeds may incorporate additional functionality, such as links to profiles of users in the feed, or indicators (e.g., badges) that provide information about such users.

In some examples, view 440 may present voter 105 with an option to view more detailed information related to ballot question 413 than what may be presented in view 440. In the example shown, voter 105 can request more detailed information by selecting user interface button 470 in view 440.

FIG. 4C presents an example view 480 that may be presented to voter 105 in response to voter 105 requesting more detailed information, such as by selecting user interface button 470 in view 440. In view 480, as in view 440, a header region (region 485 in view 480) identifies the title of a ballot or election to which the ballot question belongs (e.g., BoxCorp Proxy Card for Sep. 8, 2018). This title may correspond to a heading (e.g., heading 410) to which the selected ballot question (e.g., ballot question 413) belongs in example view 402. In view 480, region 488 identifies the ballot question at hand (e.g., ballot question 413), and presents voter 105 with the text of the ballot question (e.g., “Should BoxCorp discontinue the use of plastic bags in its California stores?”). In some examples, as with region 450 of view 440, region 488 may not present the literal text of ballot question 413, but may instead present a summarized, paraphrased, or translated version of the ballot question 413. In some examples, region 488 may present ballot question 413 exactly as it is presented in view 440 (e.g., in region 450), in order to maintain visual continuity when switching between view 440 and view 450.

In addition, in example view 480, region 490 presents various additional information related to ballot question 480. In some examples, as described above, region 490 is a scrollable region that can be scrolled by the user to hide and reveal content in region 490. In some examples, region 490 may present issues information 492 related to issues implicated by ballot question 413. Issues information 492 may include information from one or more ballot information tags (e.g., ballot information tags 212 and 214) associated with ballot question 413. For example, if ballot information tag 212 associated with ballot question 413 relates to the issue of environmental responsibility, then issues information 492 presented to voter 105 may include (e.g., as 493 in FIG. 4C) the issue of environmental responsibility. Similarly, if ballot information tag 214 associated with ballot question 413 relates to the issue of Sacramento, then issues information 492 presented to voter 105 may include (e.g., as 495 in FIG. 4C) the issue of Sacramento. Further, in some examples, issues information 492 may include an explanation of how an issue relates to ballot question 413; for instance, in example view 480, issues information 492 includes an explanation of how ballot question 413 implicates the issue of environmental responsibility (e.g., the proposal presented by ballot question 413 would eliminate environmentally harmful materials). By presenting issues information 492 to voter 105, voter 105 can clearly see the issues relevant to voter 105, and understand why VPM 100 selected ballot question 413 for presentation to voter 105. In some examples, issues information 492 may only include those issues implicated by ballot question 413 that are sufficiently relevant to voter 105 (e.g., issues that are reflected in a voter issue tag associated with voter 105). However, in some examples, issues information 492 may also include additional issues implicated by ballot question 413, even those that are less relevant to voter 105 (e.g., issues that are not reflected in a voter issue tag associated with voter 105).

In some examples, example view 480 may present voter 105 with a link to learn more about the issue; selecting this link could, for instance, present voter 105 with a separate view including more detailed information, or could bring voter 105 to third-party materials, such as a website for a government or corporation relevant to the issues. In some examples, example view 480 may present voter 105 with a link to a site maintained by a service provider or a data provider, which can include information (e.g., details, documentation) relating to the issues and/or the ballot question 413. Other suitable information that could be included with issues information 492 will be apparent and is contemplated by the disclosure.

In some examples, region 490 may present social information 496, which may include information from social media services that is relevant to ballot question 413. For example, social information 496 may identify Facebook friends of voter 105 who voted on ballot question 413; indications of how Facebook friends of voter 105 voted on ballot question 413, or on similar ballot questions. In some examples, social information 496 may include information drawn from voter issue tags, such as the percentage of voters who care about a particular issue (as reflected by voter issue tags associated with those voters) who voted in favor of ballot question 413. In some examples, social information 496 may include demographic information, such as the percentage of voters in a particular demographic group (e.g., Sacramento residents) who voted in favor of ballot question 413. In some examples, social information 496 may include links to social media services (e.g., links to profiles of Facebook friends who voted on ballot question 413). Other suitable information that could be included with social information 496 will be apparent and is contemplated by the disclosure. Social information 496 can help voter 105 understand how others, including those who share the values and beliefs of voter 105, and friends who are important to voter 105, engage with the same issues (e.g., ballot question 413) faced by voter 105. Similarly, social information 496 conveys to voters, such as voter 105, how their voting activities do not occur in a vacuum; rather, voters' activities both draw from, and affect, others around them.

In some examples, region 490 may present background information 498, which may include information helpful for voter 105 to understand ballot question 413, such as contextual information, analysis, and insight related to ballot question 413, as well as links to additional information. For example, background information 498 may include materials explaining the context in which ballot question 413 arises; a summary of the history of ballot question 413; opinions and commentary regarding ballot question 413 (e.g., a link to a statement expressing the opinion of BoxCorp's Board of Directors on ballot question 413); facts relevant to ballot question 413; analysis of ballot question 413 (e.g., government studies on the impact of the proposal of ballot question 413), or other suitable background information. Background information 498 can provide voters, such as voter 105, the information needed to fully understand and engage with issues, such as presented by ballot question 413, that may be unfamiliar, confusing, or nuanced, or that may have complex relationships with other issues.

In some examples, application 400 can present voter 105 with an opportunity to provide feedback (e.g., to a human operator of VPM 100) relating to ballot question 413. For instance, view 490 includes a selectable user interface button 495 that voter 105 can select to provide feedback, such as by opening a text entry window. Such feedback can include, for example, suggestions for additional issues implicated by ballot question 413 (which can then be used to generate additional ballot issue tags for ballot question 413); corrections of incorrect factual information regarding ballot question 413; or other information can be useful to improve the operation of VPM 100.

In some examples, the amount or type of information presented to voter 105 (e.g., in example view 480) may be based on characteristics of voter 105's voting behavior, usage of VPM 100, and/or voter issue tags. For example, if voter 105 is a frequent voter and user of VPM 100, voter 105 can be presented with more information than would a voter who only occasionally voters and engages with VPM 100. As another example, a voter with many voter issue tags corresponding to a wide range of issues, or to issues of high complexity, could be presented with more information, and/or more in-depth information, than would a user with fewer voter issue tags on less complex issues.

Referring back to FIG. 1, while VPM 100 presents ballot questions to voter 105 at stage 135 (for example, as described above with respect to FIGS. 4A-4C), VPM 100 may be configured to listen for input from voter 105 in response to those ballot questions. For example, as described above, a smartphone application (e.g., application 400) can detect input provided by the user—for instance, input provided directed to input regions 454 and/or 456, such as swiping left or right on those regions on a touch screen, or selecting a user interface button corresponding to “yes” or no.” In some examples, voter input need not be directed to any particular region of a touch screen. For instance, in some examples, voter 105 may vote yes on a ballot question by performing a first gesture (e.g., swiping left) anywhere on a touch screen, and may vote no by performing a second gesture (e.g., swiping right) on the touch screen. In some examples, as described above, other forms of input may be detected. For instance, voter 105 may provide audio input (e.g., speaking “yes” or “no” into a smartphone microphone), visual input (e.g., performing a “thumbs up” or “thumbs down” gesture into a smartphone camera, or some other input not specifically directed to an input region of application 400. Any suitable form of input may be used. Further, in some examples, voter 105 need not use a smartphone or smartphone application to provide input to VPM 100. In some examples, voter 105 can provide input using a desktop or laptop computer application; email; text message (e.g., SMS or MMS); a web interface; a microphone; a conventional telephone; a television input device (e.g., a remote control); a game console; or any other suitable input mechanism.

At stage 140 in the example shown in FIG. 1, VPM 100 receives input from voter 105, such as described above. Upon receiving input, VPM 100 may adjust the presentation to voter 105 at stage 135. For example, upon receiving input from voter 105 for a first ballot question presented, VPM 100 could present voter 105 with a second ballot question, such as the next ballot question that voter 105 has not yet voted on. In some examples, upon receiving input from voter 105 for a ballot question, VPM 100 could present voter 105 (e.g., via application 400) with a confirmation display that confirms voter 105's input, and that may display related information, such as the likely impact of voter 105's vote, or statistics related to other voters who have voted on that ballot question. With reference to FIG. 1, stage 140 may occur concurrently with stage 135, or with any other suitable stage (e.g., stages 110, 115, 120, 125, or 130). For instance, VPM 100 may continue to present a ballot question to voter 105 at stage 135 while also receiving input from voter 105 at stage 140.

In some examples, VPM 100 may be configured to cause the execution of a vote by a vote processor in accordance with input received from voter 105 at stage 140. In some examples, a vote processor may comprise a voting engine. A voting engine is a system, which may be partially automated, for receiving vote data for a voter, and using that vote data to cast a vote for the voter (e.g., by communicating the vote to the appropriate authority for processing). Such systems can comprise commercial engines for casting proxy votes for corporations; electronic voting interfaces established or authorized (e.g., by a government) for casting electronic votes in a government election; or other suitable means of using vote data to cast a vote for a voter for an election. In some examples, a voting engine may be operated by a third party with which VPM 100 communicates; in some examples, a voting engine may be incorporated directly into VPM 100. In some examples, a vote processor may comprise a person or entity (e.g., an election official, such as a registrar of voters) responsible for manually counting and/or processing votes; and instead of or in addition to communicating with a voting engine, VPM 100 may communicate (e.g., via email) with the person or entity. Other suitable means of causing the execution of a vote are contemplated and are within the scope of the disclosure.

In examples where VPM 100 causes the execution of a vote for voter 105 by a vote processor, VPM 100 may first need to generate vote data from the input received from voter 105 at stage 140. Vote data is data that includes the information needed for a vote processor (e.g., a voting engine and/or an election official) to cast a vote for voter 105. In examples in which the vote processor is a voting engine, the voting engine may specify a specific format for the vote data. For example, the voting engine could require that the vote data adhere to a specific data structure (e.g., a TCP packet), or that communications with the voting engine adhere to a specific protocol (e.g., IPv6). In some examples, the voting engine may require additional information, such as security information to verify the identity of a voter. In examples in which the vote processor is an election official, that election official may require that communications adhere to a certain format (e.g., an email including the voter's name, address, social security number, and desired vote for each ballot question). At stage 145, VPM 100 can generate the appropriate vote data from the input received from voter 105. For example, if voter 105 performed a swipe left gesture in response to being presented with ballot question 413 at stage 135 (e.g., indicating that voter 105 prefers to vote “yes” on ballot question 413), VPM could generate, based on that input, vote data indicating that a vote of yes should be cast for voter 105 with respect to ballot question 413. At stage 150, that vote data can then be communicated to the vote processor, by any appropriate means, for the vote to be executed.

In some examples, instead of or in addition to causing the execution of a vote (e.g., at stages 145 and 150), VPM 100 may perform other functionality based on the input received at stage 140. In some examples, input received from voter 105 at stage 140 may indicate that voter issue tags for voter 105 (e.g., voter issue tags identified at stage 125) are out of date and need to be updated, for instance because voter 105's beliefs have changed with respect to certain issues. In some examples, at stage 155, VPM 100 may use the input received to update voter issue tags accordingly. For instance, input received at stage 135 may indicate that voter 105 indicated no vote preference for ballot questions related to the issue of environmental responsibility; in response, at stage 155, a voter issue tag corresponding to the issue of environmental responsibility (e.g., voter issue tag 316 described above) could be updated to reflect that environmental responsibility is less important to voter 105 than previously indicated. Further, feedback input received from voter 105 (e.g., via application 400 as described above) could be used to adjust or correct the voter issue tags for voter 105.

Similarly, in some examples, input received from voter 105 at stage 140 may indicate that ballot issue tags for a ballot question (e.g., ballot issue tags identified at stage 120) are out of date and need to be updated, for instance because the ballot question no longer implicates an issue as strongly as previously thought. In some examples, at stage 160, VPM 100 may use the input received to update ballot issue tags accordingly. For instance, input received at stage 135 may indicate that voters to whom the issue of Sacramento is relevant chose overwhelmingly to vote on a specific ballot question not previously connected to Sacramento. In response, at stage 160, a ballot issue tag corresponding to the issue of Sacramento (e.g., ballot issue tag 214 described above) could be created or updated to reflect that the ballot question implicates Sacramento more strongly than previously indicated. Further, feedback input received from voter 105 (e.g., via application 400 as described above) could be used to adjust the ballot issue tags for a ballot question, such as if the feedback input indicates that the current ballot issue tags are incorrect. In some examples, feedback input received from voter 105 may be used to correct accidental or incorrect voting input from voter 105.

In some examples, VPM 100 may determine and/or present analytical information relating to ballot questions, elections, voters, or issues. For example, such analytical information could provide insight into how certain voters, or groups of voters, responded to various ballot questions. In some examples, this analytical information may be presented to voter 105 as part of a “dashboard” page associated with a smartphone application, such as application 400, as described above. In some examples, such as for corporate elections, analytical information may identify relationships between issues (e.g., issues associated with a ballot issue tag or a voter issue tag) and economic outcomes. For instance, it may be that election outcomes favoring environmental responsibility in corporate ballots correlate to an increase in a corporation's stock price. Analytical information identified by VPM 100 can indicate such relationships to the user, enabling the user to make voting decisions or investment decisions in view of the likely economic effects of those decisions. Similarly, such information may be useful to corporations in making outcome-driven decisions.

In some examples, at stage 170 in FIG. 1, VPM 100 may communicate to social media services (e.g., Facebook, Twitter, Snapchat) based on the input received from voter 105 at stage 140. In some examples, VPM 100 can utilize an Application Programming Interface (API) associated with a social media service to post content to that service on behalf of voter 105. For instance, VPM 100 may be configured to automatically post on behalf of voter 105 that voter 105 voted yes on ballot question 413. Others may then engage with voter 105 using the social media service. Further, in some examples, VPM 100 may communicate to social media services based on information from ballot issue tags (e.g., ballot issue tags 212 or 214) and/or voter issue tags (e.g., voter issue tags 312, 314, or 316). For instance, social media content posted on behalf of voter 105 relating to ballot question 413 could incorporate (e.g., via hashtags) issues corresponding to voter issue tags associated with voter 105, or to ballot issue tags associated with ballot question 413. Other suitable options for integrating with social media services will be apparent and are within the scope of the disclosure.

In some examples, VPM 100 may report vote-related data (e.g., summaries of how groups of voters voted; analytical data determined from voting patterns; relationships between voters and issues) to third parties. In some examples, such third parties may include individuals or organizations involved with an election—such as candidates or political parties in a government election; or directors and officers in a corporate election. For instance, VPM 100 could report to a corporation's board of directors that voters are voting on a particular ballot question because they have been identified as caring about a particular issue. This can provide valuable insight for policy makers, and for those with a stake in an election. Similarly, in some examples, VPM 100 can report vote-related data to media outlets for disclosure to the public—increasing public awareness and involvement, and shaping behavior, in elections and issues that may otherwise have gone unnoticed.

The examples described above may operate on one or more computers (e.g., one or more servers), including non-transitory computer readable recording media on a computer. This readable media contains the program instructions for accomplishing various steps described above. In the context of this disclosure, a computer-readable recording medium can be any medium that can contain or store programming for use by or in connection with an instruction execution system, apparatus, or device. Such computer readable media may be stored on a memory, where a memory is any device capable of storing a computer readable medium and capable of being accessed by a computer. A memory may include additional features. A computer may include a processor. A processor can be any device suitable to access a memory and execute a program stored thereon.

Communications may be transmitted between nodes over a communications network, such as the Internet. Other communications technology may include, but is not limited to, any combination of wired or wireless digital or analog communications channels, such as instant messaging (IM), short message service (SMS), multimedia messaging service (MMS) or a phone system (e.g., cellular, landline, or IP-based). These communications technologies can include Wi-Fi, BLUETOOTH, or other wireless radio technologies.

Examples of the disclosure may be implemented in any suitable form, including hardware, software, firmware, or any combination of these. Examples of the disclosure may optionally be implemented partly as computer software running on one or more data processors and/or digital signal processors. The elements and components of an example of the disclosure may be physically, functionally, and logically implemented in any suitable way. Indeed, the functionality may be implemented in a single unit, in multiple units, or as part of other functional units. As such, examples of the disclosure may be implemented in a single unit or may be physically and functionally distributed between different units and processors.

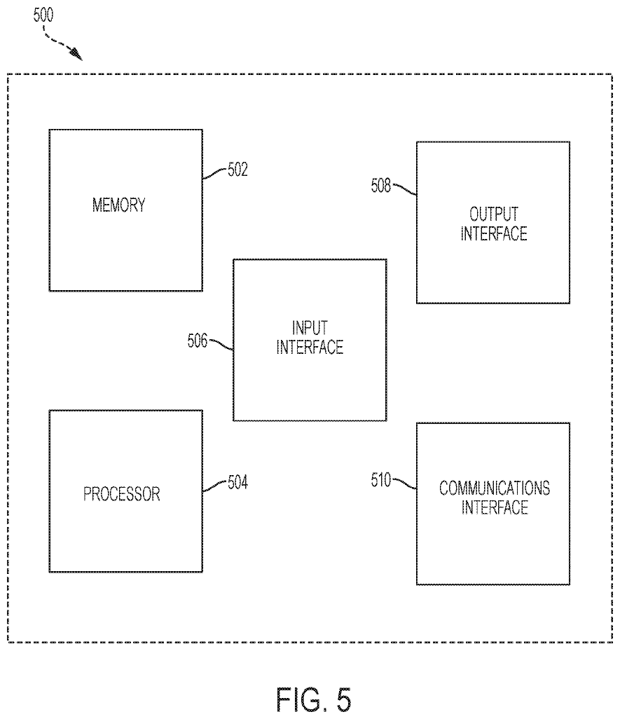

FIG. 5 illustrates an example computer 500 capable of implementing the disclosed examples. Example computer 500 includes a memory 502, a processor 504, an input interface 506, an output interface 508, and a communications interface 510.

Memory 502 may include volatile and non-volatile storage. For example, memory storage may include read only memory (ROM) in a hard disk device (HDD), random access memory (RAM), flash memory, and the like. The Operating System (OS) and application programs may be stored in ROM.

Specific software modules that implement embodiments of the described systems and methods may be incorporated in application programs on a server. The software may execute under control of an OS.

Processor 504 may include any device suitable to access a memory and execute a program stored thereon.

Input interface 506 may include a keyboard or mouse, for example. Output interface 508 may include a conventional color monitor and printer, such as a conventional laser printer. Output interface 508 may provide requisite circuitry to electrically connect and interface the display and printer to the computer system.

Communications interface 510 may allow the network and nodes to connect directly, or over another network, to other nodes or networks. The network can include, for example, a local area network (LAN), a wide area network (WAN), or the Internet. In some examples, the network, modules, and nodes can be connected to another client, server, or device via a wireless interface.

In some examples, the input interface, processor, memory, communications interface, output interface, or combinations thereof, are interconnected by a bus.

The disclosed examples could be embodied as a JAVA tool, which means it can run on any platform that is JAVA enabled. Examples can run on a web server that provides a website for administrators to monitor the system results remotely. Anyone with administrative access to the web server can connect to and use visualization tools to take actions within a visualization. The examples can run on any type of server, including virtual servers or an actual machine. While JAVA is provided as an example, any suitable programming language or technology can be used to implement the examples of the disclosure.

The disclosed examples may be embodied on a distributed processing system to break processing apart into smaller jobs that can be executed by different processors in parallel. The results of the parallel processing could then be combined once completed.

Although the present invention has been fully described in connection with examples thereof with reference to the accompanying drawings, it is to be noted that various changes and modifications will become apparent to those skilled in the art. Such changes and modifications are to be understood as being included within the scope of the claimed subject matter. The various examples of the invention should be understood that they have been presented by way of example only, and not by way of limitation. Although the invention is described above in terms of various examples and implementations, it should be understood that the various features and functionality described in one or more of the individual examples are not limited in their applicability to the particular example with which they are described. They instead can, be applied, alone or in some combination, to one or more of the other examples of the invention, whether or not such examples are described, and whether or not such features are presented as being a part of a described example. Thus the breadth and scope of the claimed subject matter should not be limited by any of the above-described examples.

Terms and phrases used in this document, and variations thereof, unless otherwise expressly stated, should be construed as open ended as opposed to limiting. As examples of the foregoing, the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known,” and terms of similar meaning, should not be construed as limiting the item described to a given time period, or to an item available as of a given time. These terms should instead be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be mad as “and/or” unless expressly stated otherwise. Furthermore, although items, elements or components of the invention may be described or claimed in the singular, the plural is contemplated to be within the scope thereof unless limitation to the singular is explicitly stated. For example, “at least one” may refer to a single or plural and is not limited to either. The presence of broadening words and phrases such as “one or more,” “at least,” “but not limited to.” or other like phrases in some instances shall not be read to mean that the narrower case is intended or required in instances where such broadening phrases may be absent. The word “exemplary” is used herein to mean “serving as an example or illustration.” Any aspect or design described herein as “exemplary” is not necessarily to be construed as preferred or advantageous over other aspects or designs.

It will be appreciated that, for clarity purposes, the above description has described examples of the invention with reference to different functional units and modules. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the claimed subject matter. Further, in some examples, some steps in the processes disclosed herein may be forgone altogether while remaining within the scope of the claimed subject matter.

What is claimed is:

1. A method comprising:
identifying a voting right corresponding to a user;
identifying, based on the voting right, a ballot question;
determining whether the ballot question is sufficiently relevant to the user;
in accordance with a determination that the ballot question is sufficiently relevant to the user:
presenting the ballot question to the user, and
in response to presenting the ballot question to the user, receiving input from the user; and
in accordance with a determination that the ballot question is not sufficiently relevant to the user, forgoing presenting the ballot question to the user.

2. The method of claim 1, further comprising:
identifying a first issue corresponding to the ballot question; and
identifying a second issue having relevance to the user;
wherein determining whether the ballot question is sufficiently relevant to the user comprises determining whether the first issue relates to the second issue.

3. The method of claim 2, wherein:
identifying a first issue corresponding to the ballot question comprises identifying a degree to which the first issue relates to the ballot question, and
determining whether the ballot question is sufficiently relevant to the user is based on the degree to which the first issue relates to the ballot question.

4. The method of claim 2, wherein:
identifying a second issue having relevance to the user comprises identifying a degree to which the second issue has relevance to the user, and
determining whether the ballot question is sufficiently relevant to the user is based on the degree to which the second issue has relevance to the user.

5. The method of claim 1, wherein receiving input from the user comprises detecting a gesture performed on a touch screen, the gesture corresponding to an intended vote with respect to the ballot question.

6. The method of claim 1, further comprising, in response to receiving input from the user:
generating vote data corresponding to the input; and
communicating the vote data to a vote processor.

7. The method of claim 1, further comprising, in response to receiving input from the user:
sending data to a social media service, the data based on the user and the ballot question.

8. A system comprising:
one or more processors;
memory storing instructions, which when executed by the one or more processors, cause the one or more processors to perform a method comprising:
identifying a voting right corresponding to a user;
identifying, based on the voting right, a ballot question;
determining whether the ballot question is sufficiently relevant to the user;
in accordance with a determination that the ballot question is sufficiently relevant to the user:
presenting the ballot question to the user, and
in response to presenting the ballot question to the user, receiving input from the user; and
in accordance with a determination that the ballot question is not sufficiently relevant to the user, forgoing presenting the ballot question to the user.

9. A non-transitory computer-readable medium storing instructions that, when executed by one or more processors of a computer system, cause the one or more processors to perform a method comprising:
identifying a voting right corresponding to a user;
identifying, based on the voting right, a ballot question;
determining whether the ballot question is sufficiently relevant to the user;
in accordance with a determination that the ballot question is sufficiently relevant to the user:
presenting the ballot question to the user, and
in response to presenting the ballot question to the user, receiving input from the user; and
in accordance with a determination that the ballot question is not sufficiently relevant to the user, forgoing presenting the ballot question to the user.
